(19) United States
(12) Patent Application Publication
(10) Pub. No.: US 2025/0325976 A1
(43) Pub. Date: Oct. 23, 2025

(54) MICROFLUIDIC DIES WITH HYDROPHILIC EPICHLOROHYDRIN-AMINE SURFACES

(71) Applicant: Hewlett-Packard Development Company, L.P., Spring, TX (US)

(72) Inventors: Mackenzie JOHNSON, Corvallis, OR (US); Beverly CHOU, San Diego, CA (US); Pooja SHAH, Corvallis, OR (US)

(73) Assignee: Hewlett-Packard Development Company, L.P., Spring, TX (US)

(21) Appl. No.: 18/870,243

(22) PCT Filed: Jun. 10, 2022
(86) PCT No.: PCT/US2022/032991

§ 371 Date: Nov. 27, 2024

(51) Int. Cl. B01L 3/02

(52) U.S. Cl. CPC B01L 3/0268; B01L 2300/0864; B01L 2300/12; B01L 2300/161; B01L 2400/0415

(57) ABSTRACT

A microfluidic die can include a fluid firing chamber and a microfluidic channel positioned to fluidically feed the fluid firing chamber. The fluid firing chamber and the microfluidic channel can be defined by a photoactive substrate having an oxygen-containing surface modified with a hydrophilic epichlorohydrin-amine.

### BACKGROUND

Microfluidic dispensing of fluids have applicability within a wide range of industries, including pharmaceutical, life science research, medical, printing, electronics manufacturing, and other industries. Manual fluid dispensing systems such as pipettes are increasingly being replaced by automated pipetting or microfluidic dispensing systems that can provide a high degree of accuracy and repeatability with improved dispense throughput. Industries can employ such automated, precision microfluidic dispensing systems for a variety of purposes, including for the preparation of biological samples for assays, nucleic acid processing, or the like in an accurate and repeatable manner.

### BRIEF DESCRIPTION OF THE DRAWINGS

FIG. 1 illustrates an example microfluidic dispenser with a dispense cassette shaped to be received by the microfluidic dispenser in accordance with the present disclosure;

FIG. 2 illustrates an example dispense cassette with additional detail depicting a microfluidic die in accordance with the present disclosure;

FIG. 3 schematically illustrates example surface modification of microfluidic dies in accordance with the present disclosure; and

FIG. 4 is a flow diagram illustrating a method of modifying a surface of a microfluidic die in accordance with the present disclosure.

### DETAILED DESCRIPTION

The present disclosure is drawn to the modification of fluidic surfaces within a microfluidic die that can be particularly useful for delivery of fluids in aqueous systems. For example, in some fluidic systems where fluids are to be delivered without the presence of surfactant, e.g., water, biological fluids, cell dispensing, etc., it can be difficult to prime fluid firing chambers through small microfluidic openings. By modifying the internal surfaces of the microfluidics in accordance with the present disclosure, acceptable priming through very small microfluidic openings can be realized in a manner that has good shelf-life.

A microfluidic dispenser can be defined as an instrument designed to dispense small quantities, e.g., in the order of picoliters (pL) of biological fluids into well-plates, or other vessels, using dispense cassettes, which may be disposable. For example, dispense cassettes can contain microfluidic dispense head(s) (or print heads) where a given microfluidic dispense head is equipped with fluidjet technology and can be specifically designed for laboratory research, for example. To illustrate, a microfluidic dispenser can be capable of dispensing cells as well as aqueous-based biomolecules in bulk fashion. This capability can be leveraged to perform dilution assays, dispense fluids for processing of nucleic acids, dispense cells, or the like. The dispense cassettes can include microfluidic dies with internal microfluidic surfaces that are surface modified as described herein. This can provide the advantage of being usable for dispensing small quantities of fluids (which includes fluid dispersions, e.g., cell dispersions) without the use of surfactant, for example, as in some instances, surfactant can be an unfavorable additive to include in biological fluidic systems.

In accordance with this and other implementations and examples, a microfluidic die is disclosed and includes a fluid firing chamber and a microfluidic channel positioned to fluidically feed the fluid firing chamber. The fluid firing chamber and the microfluidic channel in this example are defined by a photoactive substrate having an oxygen-containing surface modified with a hydrophilic epichlorohydrin-amine. The photoactive substrate can include, for example, SU8 and the oxygen-containing surface can include epoxide groups. The photoactive substrate can be oxygen plasma-treated prior to modification with the hydrophilic epichlorohydrin-amine. The microfluidic channel can include a wide fluid-receiving opening and a pinch point adjacent to the fluid firing chamber. The pinch point can be from 5 μm to 30 μm in average width perpendicular to fluid flow into the fluid firing chamber. The term “wide” is a relative term meaning it is simply wider than the pinch point, but is still within the micro-range in size, e.g., up to about 200 μm is an average width. Hydrophilic amine moieties of the hydrophilic epichlorohydrin-amines can include polyethylene oxide amines, hydrophilic amino acids, copolymers of polyethylene glycol and polylysine, or a combination thereof. In some examples, the hydrophilic amines can include polyethylene oxide amines. In other examples, the hydrophilic amine moieties can include the structure of Formula I:

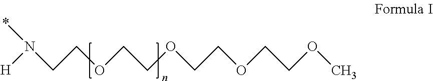

where n is 0 or an integer from 1 to 20. In other examples, the hydrophilic amine moieties can include the hydrophilic amino acids and can be selected from lysine, glycine, alanine, aspartic acid, glutamic acid, asparagine, glutamine, serine, arginine, or a combination thereof.

In other examples, a dispense cassette shaped to be received by a microfluidic dispenser is disclosed. The dispense cassette includes a plurality of fluidic architectures that individually have a fluid feed slot, and a plurality of microfluidic channels positioned along the fluid feed slot to individually receive and pass fluid from the fluid feed slot into corresponding fluid firing chambers. The microfluidic channels are defined by a surface including hydrophilic epichlorohydrin-amine. In some examples, the microfluidic channel can include a wide fluid-receiving opening and a pinch point adjacent to the fluid firing chamber. In other examples, the surface can be an oxygen plasma-treated surface and the hydrophilic epichlorohydrin-amine can be attached to the oxygen plasma-treated surface.

In other examples, a method of modifying a surface of a microfluidic die includes modifying an oxygen-containing surface of a fluidic interface within a microfluidic die with epichlorohydrin to provide epoxide groups at the fluidic interface, and reacting hydrophilic amines with the epoxide groups to form hydrophilic epichlorohydrin-amines at the fluidic interface. In some examples, the oxygen-containing surface can be from a photoactive substrate including SU8. The SU8 can be oxygen plasma-treated prior to modifying with the epichlorohydrin. In other examples, the fluidic surface of the microfluidic die can include microfluidic channels having a wide fluid-receiving opening and a pinch point adjacent to a fluid firing chamber, wherein the hydrophilic epichlorohydrin-amines are attached at the pinch point. In still other examples, the hydrophilic epichlorohydrin-amines include hydrophilic amines selected from polyethylene oxide amines, hydrophilic amino acids, copolymers of polyethylene glycol and polylysine, or a combination thereof.

In these examples, it is noted that when discussing the microfluidic dies, the dispense cassettes, and/or the methods of the present disclosure, any such discussions can be considered applicable to the other examples, whether or not they are explicitly discussed in the context of that example. Thus, for example, in discussing details about a fluid firing chamber of the microfluidic dies, such discussion also relates to the dispense cassettes and methods described herein, and vice versa.

### Microfluidic Dispensers

A microfluidic dispenser 100 (which may be described alternatively as a microfluidic dispensing system) suitable for ejection of fluid droplets 120 is shown in FIG. 1. While the microfluidic dispenser is illustrated and described herein in terms of a microfluidic dispenser useful in pharmaceutical, biological and other life science assays and processing, testing drug dose responses, independent titrations, other low-volume dispensing, or the like, it is to be understood that the described mechanisms and concepts can apply in a similar manner to other fluid dispensers.

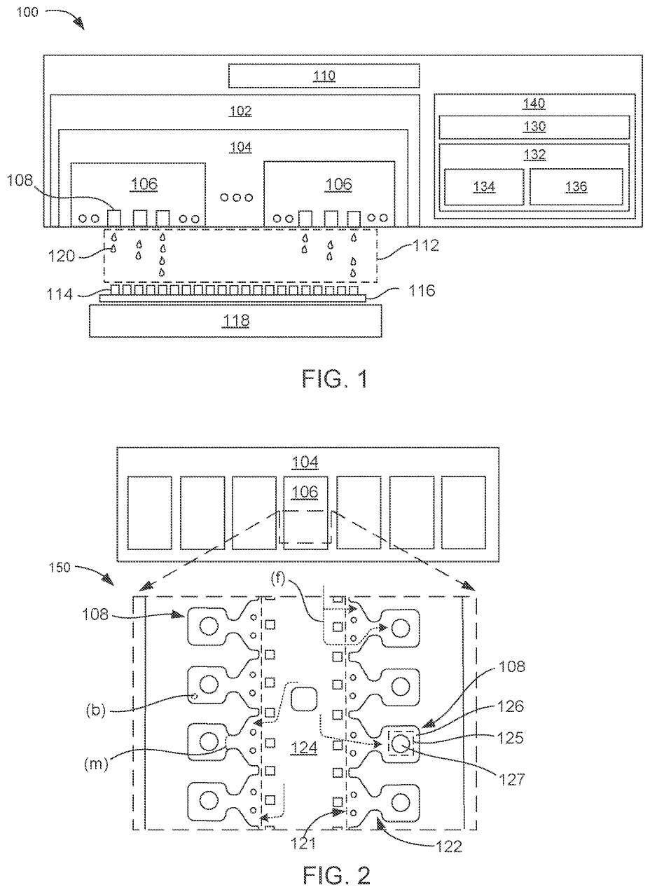

In accordance with this, as an example, the microfluidic dispenser 100 can include a receiving station 102 to receive a microfluidic dispense head(s) 106 with an ejector(s) 108. The dispense head(s) can include microfluidic dies, such as those shown by way of example in FIG. 2 at 150. Also, as shown in FIG. 1, in some specific examples the receiving station can receive a dispense cassette 104 that includes multiple microfluidic dispense heads. An example dispense cassette can include multiple microfluidic dispense heads arranged in parallel across the length of the dispense cassette. Different dispense cassettes can include different types of microfluidic dispense heads. The types of microfluidic dispense heads that may be integrated onto the dispense cassette can be identified by the microfluidic dispenser through a dispense cassette reader that can read a cassette identifier on the dispense cassette.

The example microfluidic dispenser 100 of FIG. 1 can be used as part of a system which includes a well plate 116 with numerous wells 114, for example, into which fluid droplets 120 can be dispensed from the microfluidic dispense head(s) 106 of the dispense cassette 104. A well plate transport assembly 118 can position and reposition the well plate and wells relative to the dispense heads as fluid droplets are being dispensed. Thus, a fluid dispense zone 112 is defined adjacent to the ejectors 108 in an area between the dispense heads and the wells on the well plate.

The microfluidic dispenser 100 can also include a controller 140. In some examples, the controller can, using a processor (CPU) 130, receive the user input 134 via a user interface 110. The controller can control various operations of the microfluidic dispenser for facilitating, for example, calculating a dispense volume 136 of a fluid based on a user input, as well as instructing the fluid to be dispensed from the microfluidic dispense head(s) 106 in accordance with the calculated dispense volume. The controller can include a processor and a memory 132. The controller may additionally include other electronics (not shown) for communicating with and controlling various components of the microfluidic dispenser. Such other electronics can include, for example, discrete electronic components and/or an ASIC (application specific integrated circuit). The memory can include both volatile (i.e., RAM) and nonvolatile memory components (e.g., ROM, hard disk, optical disc, CD-ROM, magnetic tape, flash memory, etc.). The components of the memory include non-transitory, machine-readable (e.g., computer/processor-readable) media that can provide for the storage of machine-readable coded program instructions, data structures, program instruction modules, JDF (job definition format), and other data and/or instructions executable by the processor of the microfluidic dispenser.

### Dispense Cassettes and Microfluidic Dies

Referring more specifically to FIG. 2, a dispense cassette 104 is shown that can include one or a series of dispense heads 106. The dispense heads can include, in part, a microfluidic die 150, which in this instance is configured to receive fluid to be ultimately dispensed from one or more of a series of ejectors 108. The fluid is shown in FIG. 2 with dotted lines indicting a few example fluid flow (f) paths. More specifically in the example shown, this particular dispense cassette shows, in-part, seven microfluidic dispense heads. Individual microfluidic dispense heads can include a feed slot 124 into which fluid can be added for dispensing through the ejector(s). In various examples, a microfluidic dispense head equipped with a microfluidic die can implement different ejection technologies to dispense fluid drops. For example, in a thermal drop-on-demand ejection process, a microfluidic dispense head can include a series of ejectors that individually include firing chambers 126 containing a resistive heating element 125 which may be used to eject fluid from the firing chamber via an ejection nozzle 127. The individual firing chambers can be in fluidic communication with the feed slot reservoir via a corresponding microfluidic channel, which in this instance includes a fluid-receiving opening 121 (adjacent the feed slot) and a pinch point 122 (adjacent the firing chamber). A fluid drop can thus be received from the feed slot to be dispensed or ejected from a firing chamber by passing a current through the resistive heating element. The current heats the resistive heating element, causing rapid vaporization of fluid around the element and forming a vapor bubble that generates a pressure increase that ejects a fluid drop out of the firing chamber through the ejection nozzle.

On the other hand, in a piezoelectric drop-on-demand fluid ejection process, the microfluidic dispense head(s) 106 can include a piezoelectric material (not shown) associated with the individual firing chambers 126 instead of the resistive heater 125. The piezoelectric material changes shape when a voltage is applied, and the change in shape generates a pressure pulse in the fluid within the firing chamber that forces a drop of fluid out of the chamber through the ejector(s) 108. A microfluidic dispense head and its various components and structures can be manufactured using assorted microfabrication techniques including microlithography, thin film construction, etching, bonding, and so on.

In evaluating whether or not a fluid flow (f) provides fluid from the feed slot 124 and ultimately into the firing chamber 126, passing adequately through the pinch point 122, evaluation of fluid priming can be carried out, as described by way of example in Example 4 below. For example, a fluid sample, such as an aqueous fluid sample devoid of surfactant, e.g., water, biological buffer, etc., can be introduced through the fluid receiving opening 121 of a microfluidic channel to see if the firing chamber can adequately pass through the pinch point to prime the firing chamber. In microfluidic dies, such as those of the present disclosure, the pinch point can be included to provide fluid dynamics that assist in filling the firing chamber, but can be very narrow when the firing chamber is designed to eject very small droplets of fluid, e.g., in the picoliter (pL) range. For example, the pinch point may be from 5 μm to 30 μm, or 7.5 μm to 15 μm in average width (perpendicular to fluid flow into the fluid firing chamber).

One method of determining whether the firing chamber can be appropriately primed through the pinch point can include inspecting the firing chamber using an inverse microscope to evaluate whether or not adequate priming occurred. “Priming” can be defined as having occurred if the fluid sample was able to move through the pinch point and into the firing chamber. Filling of the firing chamber indicates that priming occurred. The presence of air bubbles, shown in FIG. 2 by example as (b) in the firing chamber, is acceptable provided the firing chamber is substantially filled with the sample fluid, as small air bubbles would ultimately be evacuated during use. Priming “failure,” on the other hand can be defined as the sample fluid not filling the firing chamber. An example of what this may look like under a microscope would include the presence of a liquid meniscus, shown in FIG. 2 by example as (m) at the pinch point, indicating that the fluid sample failed to fill the firing chamber, e.g., the chamber remains filled with air.

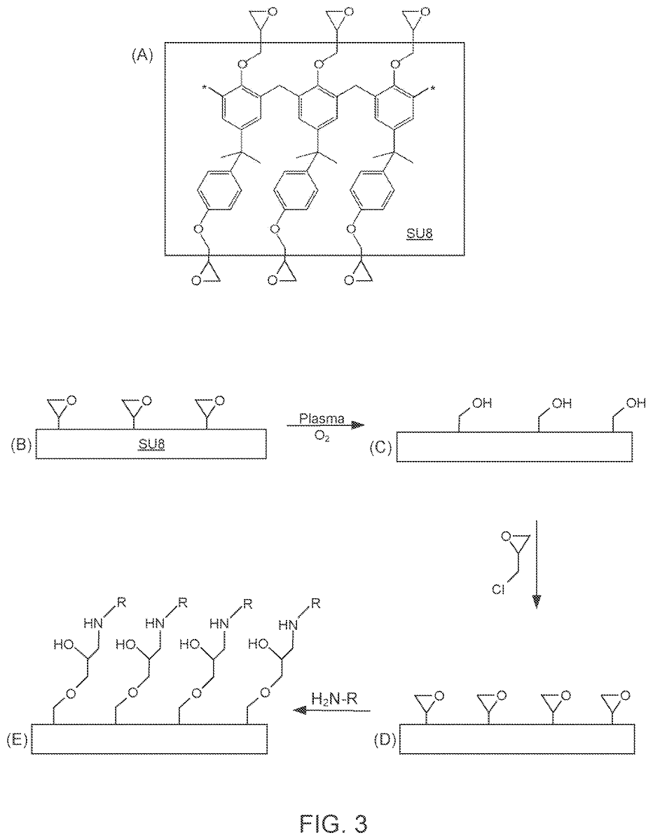

Referring to FIG. 3, the chemistry applied to interior surfaces of the microfluidic dies (shown at 150 in FIG. 2) is shown schematically at FIG. 3. As an initial matter, the substrate that is used can be a photoactive substrate that includes oxygen at the surface, e.g., epoxide groups, hydroxyl groups, etc. In the examples described herein, SU8 material is described as the substrate by way of example, as it is an epoxy-based negative photoresist material often used for the formation of microfluidic architectures. It is understood that SU8 as described hereinafter by way of example, and other material substrates with oxygen-containing surfaces can likewise be used. Thus, an example general structure of SU8 material, which can be used as a substrate in accordance with the present disclosure, is shown at (A). As shown, SU8 includes surface epoxide groups. For simplicity, SU8 (unmodified) is also shown at (B) with just the surface epoxide groups. Thus, (A) and (B) depict the same SU8 structure. In further detail, native SU8 is a material that can be used for preparing small microfluidic architectures that can be suitable for preparing microfluidic dies for channeling and ejecting fluid. However, SU8 tends to be hydrophobic. Aqueous fluids, particularly fluids that do not include surfactant make this material often unsuitable for priming dispense heads through very small microfluidic channels. In some examples, pinch points, such as those shown in FIG. 2, can be very small, e.g., from 5 μm to 30 μm, or from 7.5 μm to 15 μm. When a dispense head cannot be properly filled with fluid, the fluid cannot be ejected properly with good reliability over time.

For applications where the sample fluid is aqueous in nature, and where the fluid would benefit from being devoid of surfactant, e.g., biological samples with cells and/or proteins where biocompatibility can be an issue due to biological material damage, the surface of the microfluidic die can be modified to be more hydrophilic instead. By subjecting the SU8 microfluidic die to an oxygen plasma treatment process under vacuum to open the surface epoxide rings, as shown at (C) in FIG. 3, the surface can become compatible with surfactant-free aqueous fluid samples. In further detail, the oxygen plasma treatment tends to drove O radicals to the surface, which can have the additional impact of causing ion bombardment and surface roughness/surface energy changes as well. While oxygen plasma treatment can be effective for generating good priming of aqueous fluid samples (even without surfactant), it has been found that this treatment has a short shelf-life, e.g., a matter of weeks when under heat and humidity challenge. Thus, to preserve the hydrophilic nature after plasma treatment, one solution may be to use extensive/expensive packaging to retain the hydrophilic properties until an end user is ready to begin using the cassette with a microfluidic dispenser.

In accordance with examples of the present disclosure, the surface energy of the SU8 surface can be further modified after oxygen plasma treatment to increase the shelf-life of the treated surface. As shown at (D) in FIG. 3, epichlorohydrin can be reacted with the oxygen plasma-treated surfaces shown at (C) to effectively re-close the epoxide groups. That stated, there is some evidence that by opening the epoxide groups of the native SU8 using an oxygen plasma treatment, and then effectively re-introducing epoxide groups from the epichlorohydrin back to the surface, the surface density of available epoxide groups for a subsequent reaction may be increased. This is evidenced by the data presented in Example 4 hereinafter. With the epichlorohydrin having now reacted with the oxygen plasma-treated surfaces of the microfluidic dies (particularly at the pinch points in some examples), the reaction of a hydrophilic amine with the surface epoxide groups (from free O radicals generated from the epichlorohydrin and/or the oxygen plasma treatment) can generate a structure similar to that shown at (E) in FIG. 3. Structure (E) is shown by way of example, as any of a number of hydrophilic amines that can be used to modify the surface to add additional hydrophilicity to the SU8 surface within the microfluidics of the microfluidic die. This added hydrophilic moiety to the surface of the SU8 effectively provides a more robust, longer lasting hydrophilic surface with a suitable surface tension for aqueous samples, even in the absence of surfactant.

Though the example of FIG. 3 is provided, it is understood that to attach the hydrophilic amine moieties to the photoactive surface after the epichlorohydrin reaction, the oxygen plasma treatment may be omitted. However, better shelf-life of the surface (long lasting effect) can be achieved by carrying out each of the surface reactions described in this example, e.g., oxygen plasma treatment then epichlorohydrin reaction then hydrophilic amine reaction at the surface. Either way, the resulting surface modification is in the form of a hydrophilic epichlorohydrin-amine. With the preliminary step of including oxygen plasma treatment, the surface density of 0 radicals for subsequent reaction can be increased, which may explain the enhanced shelf-life to some degree.

When using aqueous fluids (particularly without the presence of surfactant), the use of SU8 without modification in a microfluidic die provides a low surface energy surface that tends to generate high water contact angles. This is often not suitable for the aqueous fluid in passing narrow pinch points, for example. On the other hand, the introduction of oxygen plasma treatment to the SU8 does increase the surface energy of the microfluidic die, generating a lower water contact angle; however, the shelf-life of this oxygen plasma-treated surface structure can be more limited as shown in Example 4. On the other hand, by carrying out both oxygen plasma treatment and the hydrophilic epichlorohydrin-amine modifications shown in FIG. 3, a high surface energy can be achieved with a low water contact angle, and furthermore, the shelf-life of the surface treatment and modification can be increased substantially.

Example hydrophilic amines that can be used to modify the epichlorohydrin-modified surface of the SU8 include polyethylene oxide amines, hydrophilic amino acids, copolymers of polyethylene glycol and polylysine, or combinations thereof. For example, the hydrophilic amines can include a polyethylene oxide amine(s) having a molecular weight from 150 Daltons to 20,000 Daltons, from 150 Daltons to 10,000 Daltons, from 150 Daltons to 5,000 Daltons, from 150 Daltons to 2,000 Daltons, from 150 Daltons to 1,000 Daltons, or from 500 Daltons 20,000 Daltons. In some more specific examples, the hydrophilic amines can include the structure of Formula I:

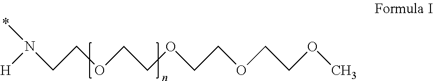

where n is 0 and/or n is an integer from 1 to 50, from 1 to 25, from 1 to 20, from 1 to 10, or from 2 to 25. As also mentioned, in some other examples, the hydrophilic amines provided by hydrophilic amino acids that can be selected for use include lysine, glycine, alanine, aspartic acid, glutamic acid, asparagine, glutamine, serine, arginine, or a combination thereof.

### Methods of Modifying a Surfaces of Microfluidic Dies

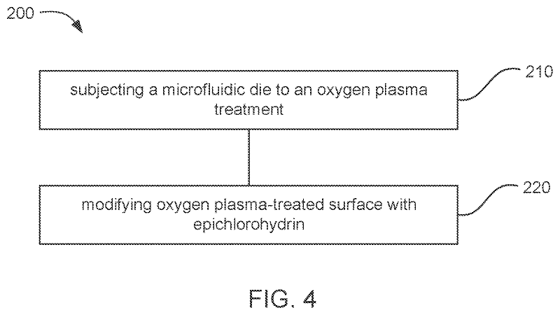

FIG. 4 is a flow diagram of an example method 200 of modifying surfaces of microfluidic dies. In this example, the method can include modifying 210 an oxygen-containing surface of a fluidic interface within a microfluidic die with epichlorohydrin to provide epoxide groups at the fluidic interface, and reacting 220 hydrophilic amines with the epoxide groups to form hydrophilic epichlorohydrin-amines at the fluidic interface. In some examples, the oxygen-containing surface can be from a photoactive substrate including SU8. The SU8 can be oxygen plasma-treated prior to modifying with the epichlorohydrin. In other examples, the fluidic surface of the microfluidic die can include microfluidic channels having a wide fluid-receiving opening and a pinch point adjacent to a fluid firing chamber, wherein the hydrophilic epichlorohydrin-amines are attached at the pinch point. In still other examples, the hydrophilic epichlorohydrin-amines include hydrophilic amines selected from polyethylene oxide amines, hydrophilic amino acids, copolymers of polyethylene glycol and polylysine, or a combination thereof. Where oxygen-plasma treatment is used, the oxygen plasma-treated surface can also include opened epoxide groups that also covalently bonded to a plurality of the hydrophilic amines. This may result in increased surface density of available surface groups for attaching the hydrophilic amines to the surface thereof. This enhanced density is supported by experimentation where the hydrophilic amines attached to native SU8 did not work as well or last as long as comparative oxygen plasma treated surfaces. However, by using both processes (oxygen plasma treatment and epichlorohydrin/hydrophilic amine modification), the surface energy and shelf-life outperformed samples where only one of these two processes was carried out. In other examples, the microfluidic die can include microfluidic channels having a wide fluid-receiving opening and a pinch point adjacent to a fluid firing chamber. In this example, by causing this process to coat the surface at the pinch point (shown in FIG. 2), better aqueous fluid priming and longevity occurs compared to other samples where neither or only one process is carried out. In still other examples, the hydrophilic amines that are used can include polyethylene oxide amines, hydrophilic amino acids, copolymers of polyethylene glycol and polylysine, or combinations thereof, similar to that described in relation to previous examples.

While the flowchart presented for this disclosure can imply a specific order of execution, the order of execution can differ from what is illustrated. For example, the order of two or more blocks can be rearranged relative to the order shown. Further, two or more blocks shown in succession can be executed in parallel or with partial parallelization. In some configurations, block(s) shown in the flow chart can be omitted or skipped. A number of counters, state variables, warning semaphores, or messages can be added to the logical flow for purposes of enhanced utility, accounting, performance, measurement, troubleshooting or for similar reasons.

Furthermore, since the subject matter has been described in language specific to structural features and/or operations, it is to be understood that the subject matter defined in the appended claims is not limited to the specific features and operations described above. Rather, the specific features and acts described above are disclosed as example forms of implementing the claims. Numerous modifications and alternative arrangements can be devised without departing from the scope of the described disclosure.

### Definitions

It is noted that, as used in this specification and the appended claims, the singular forms “a,” “an,” and “the” include plural referents unless the context clearly dictates otherwise. For example, in referring to “a nozzle,” this includes a single nozzle, but could also be multiple nozzles, depending on the fluid volume to be dispensed relative to the drop volume size ejectable from individual nozzles.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if individual numerical values and sub-ranges are explicitly recited. As an illustration, a numerical range of “about 1 wt % to about 20 wt %” should be interpreted to include the explicitly recited values of about 1 wt % to about 20 wt %, and also to include individual values and sub-ranges within the indicated range. Thus, included in this numerical range are individual values such as 2, 3.5, 10, 15, and sub-ranges such as from 1-10, from 2-15, and from 10-20, etc. This same principle applies to ranges reciting a single numerical value. Furthermore, such an interpretation should apply regardless of the breadth of the range or the characteristics being described.

The following illustrates examples of the present disclosure. Numerous modifications and alternative devices, methods, and systems may be devised without departing from the scope of the present disclosure. The appended claims are intended to cover such modifications and arrangements.

### EXAMPLES

### Example 1—Oxygen Plasma Treatment of Microfluidic Dies

SU8 microfluidic dies for use in a dispense head cartridge were treated by an oxygen plasma process to modify the surface of the interior microfluidics. The SU8 microfluidic dies included an ink feed slot, multiple firing chambers, and microfluidic channels with pinch points for feeding the firing chambers from the ink feed slot, similar to that shown in FIG. 2. The oxygen plasma process used to treat the interior microfluidics included evacuating a treatment chamber at 80 mTorr as the pump down pressure, followed by a 400 O₂ sccm (cubic centimetre per minute) flow rate of oxygen at 540 W with a 60 second plasma treatment discharge. The target process was about 400 mTorr. This process released oxygen free radicals that generated surface hydroxyls on the SU8 surface by opening up the epoxide ring structures of the SU8 surface.

### Example 2—Treatment of SU8 Microfluidic Dies after Oxygen Plasma Treatment with Epichlorohydrin

With the epoxide groups of the SU8 surface opened by the oxygen plasma treatment of Example 1, epichlorohydrin is reacted with the surface to re-introduce epoxide groups to the surface of the SU8 surface. The epichlorohydrin was reacted with the SU8 surface as follows. First, the SU8 microfluidic dies were rinsed with water, isopropyl alcohol, and acetone. The rinsed SU8 microfluidic dies were then treated in a mixture of 2.5 mL 2M sodium hydroxide (NaOH) and 3 mL of water for 30 minutes at 40° C. After 30 minutes, 3 mL of isopropyl alcohol was added to the solution followed by 0.5 mL of epichlorohydrin to make a 5.55 vol % epichlorohydrin solution in contact with the surface of the oxygen plasma-treated SU8, which was then incubated for 2 hours at 40° C. The isopropyl alcohol assists with dissolving the epichlorohydrin with the assistance of gentle shaking within about 3 minutes. In some instances, if the epichlorohydrin does not completely dissolve, 0.1 mL increments of additional isopropyl alcohol can be added until the epichlorohydrin is completely dissolved. The application or etch may be from a 5 vol % to 5.5 vol % epichlorohydrin solution, depending on how much additional epichlorohydrin is added dropwise, if any. After 2 hours of incubation, the incubation solution is discarded and the SU8 microfluidic dies were rinsed in deionized water, leaving an epichlorohydrin-modified SU8 microfluidic die.

It is believed that by opening the rings on the SU8 microfluidic dies by oxygen plasma treatment, the surface density of functional groups may be increased. Closing the previously opened epoxide rings with epichlorohydrin may seem redundant, but as shown by the data presented below, this process appears to increase the density of surface epoxide rings available for subsequent modification.

### Example 3—Hydrophilic Modification of SU8 Microfluidic Dies

A 10 mL solution of deionized water and methyl-PEG₄-Amine (177.24 Mw; 0.974 Density; linear compound with a terminal methyl group, a terminal amino group, and four ethylene oxide subunits) was prepared at a 60 mM concentration. The solution was then reacted with the epichlorohydrin-modified SU8 microfluidic dies of Example 2 and incubated at 40° C. for 24 hours. The reaction between the surface epoxide rings and the amino groups of the methyl-PEG₄-amine occurred resulting in the structure shown by way of example in FIG. 3 at (E), which is described in shorthand herein as a “hydrophilic epichlorohydrin-amine.” The SU8 microfluidic dies were then rinsed in deionized water and stored.

### Example 4—Priming Performance of SUB Microfluidic Dies

The SU8 microfluidic dies prepared in accordance with Example 3 (Die 1) were evaluated for wetting performance and duration of wetting performance initially and at various time intervals upon a heat and humidity chamber challenge at 30° C. and 80% R.H. Thus, evaluation of wetting or “Priming” occurred initially (prior to challenge), and then again every three days during the challenge until “Failure” was observed, as described below.

As positive controls, some SU8 microfluidic dies were treated only with the plasma oxygen treatment of Example 1 (Control Die 1); and some of the SU8 microfluidic dies were treated only with the methyl-PEG₄-amine as described in Example 2 except that no plasma oxygen treatment occurred, e.g., using the native epoxide surface groups found inherently on SU8 microfluidic dies (Control Die 2). Additionally, a negative control of completely untreated SU8 microfluidic dies (Negative Control Die 1) was also included in the evaluation.

The wetting performance test conducted included dropping 10 μL of deionized water into the well of an individual dry firing chamber so that the water would need to pass through the pinch point, which was about 10 μm in this example. The pinch point and firing chamber was then inspected using an inverse microscope to evaluate whether or not there was adequate priming for the water to enter the firing chamber through the pinch point. “Priming” was defined as having occurred with the deionized water moving through the pinch point and into the firing chamber. The presence of air bubbles in the firing chamber was acceptable in the firing chamber, provided the deionized water was able to substantially fill the firing chamber. “Failure” was defined as showing a meniscus at the pinch point, indicating that the deionized water failed to fill the firing chamber. The data collected is shown in Table 1, as follows:

TABLE 1
Priming Performance Comparison

| | Oxygen | Hydrophilic | Concentration | | |
|---|---|---|---|---|---|
| | Plasma | Epichlorohydrin- | Hydrophilic | Priming | |
| Microfluidic Die ID | Treatment | Amine Modification | Group | Failure | |
| Die 1 | Yes | CH3-PEG₄-NH-(EPI) | 60 mM | No Failure | |
| | | | | beyond 24 days | |
| Control Die 1 | Yes | No | N/A | 18 | days |
| Control Die 2 | No | CH3-PEG₄-NH-(EPI) | 60 mM | 9 | days |
| Negative Control Die 1 | No | No | N/A | 0 | days |

As can be seen by Table 1, without surface treatment of any type (Negative Control Die 1), a surfactant-free fluid, i.e. deionized water, will not prime properly through the pinch point even initially. Oxygen plasma treatment alone (Control Die 1) modifies the surface sufficient so that priming with deionized water can occur after challenge up to at least about 15 days, but fails at day 18. In a real world ambient conditions, that may provide a few months until failure would occur on average. Like the oxygen plasma treatment, by applying only the hydrophilic epichlorohydrin-amine to the native SU8 (Control Die 2), the SU8 microfluidic die can prime the fluidic firing chamber past the pinch point, but fails at day 9 under challenge conditions. Thus, there is improvement over no surface modification to the SU8 material. On the other hand, by first subjecting the SU8 microfluidic die to an oxygen plasma treatment followed by epichlorohydrin and hydrophilic amine modification (Die 1), failure was not observed beyond 24 days (when testing was ceased without discovering the exact failure time frame beyond 24 days).

1. A microfluidic die, comprising:
a fluid firing chamber; and
a microfluidic channel positioned to fluidically feed the fluid firing chamber,
wherein the fluid firing chamber and the microfluidic channel are defined by a photoactive substrate having an oxygen-containing surface modified with a hydrophilic epichlorohydrin-amine.

2. The microfluidic die of claim 1, wherein the photoactive substrate includes SU8 and the oxygen-containing surface includes epoxide groups.

3. The microfluidic die of claim 1, wherein the photoactive substrate is oxygen plasma-treated prior to modification with the hydrophilic epichlorohydrin-amine.

4. The microfluidic die of claim 1, wherein the microfluidic channel includes a wide fluid-receiving opening and a pinch point adjacent to the fluid firing chamber, wherein the pinch point is from 5 μm to 30 μm in average width perpendicular to fluid flow into the fluid firing chamber.

5. The microfluidic die of claim 1, wherein hydrophilic amine moieties of the hydrophilic epichlorohydrin-amines include polyethylene oxide amines, hydrophilic amino acids, copolymers of polyethylene glycol and polylysine, or a combination thereof.

6. The microfluidic die of claim 5, wherein the hydrophilic amine moieties include the polyethylene oxide amines.

7. The microfluidic die of claim 1, wherein the hydrophilic amine moieties include the structure of Formula I: 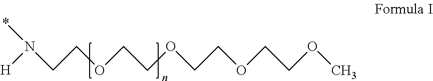
where n is 0 or an integer from 1 to 20.

8. The microfluidic die of claim 1, wherein the hydrophilic amine moieties include the hydrophilic amino acids selected from lysine, glycine, alanine, aspartic acid, glutamic acid, asparagine, glutamine, serine, arginine, or a combination thereof.

9. A dispense cassette shaped to be received by a microfluidic dispenser, the dispense cassette comprising a plurality of fluidic architectures, the plurality of architectures individually including:
a fluid feed slot, and
a plurality of microfluidic channels positioned along the fluid feed slot to individually receive and pass fluid from the fluid feed slot into corresponding fluid firing chambers, wherein the microfluidic channels are defined by a surface including hydrophilic epichlorohydrin-amine.

10. The dispense cassette of claim 9, wherein the microfluidic channel includes a wide fluid-receiving opening and a pinch point adjacent to the fluid firing chamber.

11. The dispense cassette of claim 9, wherein the surface is an oxygen plasma-treated surface and the hydrophilic epichlorohydrin-amine is attached to the oxygen plasma-treated surface.

12. A method of modifying a surface of a microfluidic die, comprising:
modifying an oxygen-containing surface of a fluidic interface within a microfluidic die with epichlorohydrin to provide epoxide groups at the fluidic interface; and
reacting hydrophilic amines with the epoxide groups to form hydrophilic epichlorohydrin-amines at the fluidic interface.

13. The method of claim 12, wherein the oxygen-containing surface is from a photoactive substrate including SU8, wherein the SU8 is oxygen plasma-treated prior to modifying with the epichlorohydrin.

14. The method of claim 12, wherein the fluidic surface of the microfluidic die includes microfluidic channels having a wide fluid-receiving opening and a pinch point adjacent to a fluid firing chamber, wherein the hydrophilic epichlorohydrin-amines are attached at the pinch point.

15. The method of claim 12, wherein the hydrophilic epichlorohydrin-amines include hydrophilic amine moieties selected from polyethylene oxide amines, hydrophilic amino acids, copolymers of polyethylene glycol and polylysine, or a combination thereof.
